(19) United States
(12) Patent Application Publication
(10) Pub. No.: US 2012/0000379 A1
(43) Pub. Date: Jan. 5, 2012

(54) METHOD FOR PRODUCING A STAMP FOR HOT EMBOSSING

(75) Inventors: Jesse Greener, Toronto (CA); Wei Li, Toronto (CA); Eugenia Kumacheva, Toronto (CA)

(73) Assignee: THE GOVERNING COUNCIL OF THE UNIVERSITY OF TORONTO, Toronto, ON (CA)

(21) Appl. No.: 13/147,863

(22) PCT Filed: Feb. 3, 2010
(86) PCT No.: PCT/CA2010/000144

§ 371 Date: Sep. 22, 2011

Related U.S. Application Data
(62) Division of application No. 61/202,188, filed on Feb. 4, 2009.

(51) Int. Cl. B41F 19/02; B44C 1/24

(52) U.S. Cl. 101/27; 101/32

(57) ABSTRACT

The present invention provides a process for producing a stamp for hot embossing (HE). The stamp can be constructed from any photo-resist epoxy that is stable at temperatures equal to the glass transition temperature (T_{g}) of the material to be stamped. The stamp can be used repeatedly without significant distortion of features. The stamp benefits from low relative cost, high fidelity of features in all three-dimensions and fast construction. The process for producing a stamp for hot embossing from a resist, comprising the steps of producing a seed layer L1 from a selected photoresist polymer material, soft baking the seed layer L1, exposing said seed layer L1 to initiate cross-linking and then post-exposure bake L1 to fully cross-link it, coating the cross-linked seed layer L1 with a second photoresist polymer layer L2; soft baking the second photoresist polymer layer L2; applying a mask to the top surface of the soft baked layer L2 and illuminating the unmasked portions of the soft baked layer L2 with UV radiation through the mask, wherein the exposed areas form the pattern of the embossing features, washing away un-exposed regions of the photoresist with a developer to leave behind a relief pattern formed in the second photoresist polymer layer L2, which relief pattern corresponds to a pattern in the mask.

### CROSS REFERENCE TO RELATED APPLICATION

This patent application relates to, and claims the priority benefit from, U.S. Provisional Patent Application Ser. No. 61/202,188 filed on Feb. 4, 2009 entitled METHOD FOR PRODUCING A STAMP FOR HOT EMBOSSING, filed in English, and which is incorporated herein by reference in its entirety.

### FIELD OF THE INVENTION

The present invention relates to a process for producing a stamp for hot embossing (HE) made from any resist that is stable at temperatures equal to the glass transition temperature (T_{g}) of the material to be stamped.

### BACKGROUND OF THE INVENTION

Chemical reactions performed in microfluidic reactors are characterized by efficient mixing, enhanced heat and mass transfer, protection from contaminations, and the ability to perform multi-step reactions in a continuous mode. There is a growing interest in rapid and cost-efficient fabrication of microreactors with the purpose of high throughput screening and optimization of formulations or increased productivity of microfluidic synthesis.

Hot embossing (HE) is a promising technique for the fabrication of microfluidic reactors with channel dimensions on the order of tens to hundreds of micrometers and high aspect ratio features. This method requires relatively low heating (in comparison with e.g., injection molding), thereby reducing residual thermal stress in the fabricated device.

Embossing is the process of creating a three-dimensional image or design on surfaces of ductile materials. Stamps for hot embossing (HE) include metal stamps such as nickel or brass which are currently the industry standard. These stamps have good thermal properties and are quite robust with a long lifetime. However, they are expensive and slow to manufacture. Silicon Carbide (SiC) based hot embossing stamps are robust but are limited in that one can obtain only one stamp per mould, and are time consuming to make and are expensive. Etched silicon stamps are inexpensive, fast to manufacturer, but suffer from a very limited lifetime.

High temperature epoxy stamps have been created using Polydimethylsiloxane (PDMS) master moulds (Oleschuk Sensors and Actuators B 107 (2005) 632-639), but suffer from problems, which we will outline below.

EP 1 413 923 A2 disclose method of producing stamps which is labourious and technologically-intensive but nevertheless gives a very rugged, reusable (SiC) stamp which gives it commercial utility. That publication discloses a robust nano-imprinting stamp where the active embossing features and the underlying foundation layer are made from micro-cast silicon carbide (SiC). The method of producing stamps disclosed in EP 1 413 923 A2 involves depositing a release layer (several μm) onto a substrate (via chemical vapor deposition (CVD), physical vapor deposition (PVD), sputtering, etc). A mould layer is then deposited on the release layer (via CVD, PVD, sputtering, etc). The process discloses calls for the mould layer to be lithographically patterned with a mask and then etched (via reactive ion etching (RIE), for example) down to the release layer. This mould layer is the completely filled with the stamp material (SiC) and the portion of the SiC, which is above the mould layer (the foundation layer) must then be precisely planed (via chemical mechanical planarization (CMP), for example). A handling substrate is then glued onto the back of the SiC's planed side using a glue. Releasing the stamp from the mould requires another process, which results in the mould being destroyed by aggressive etching (by HF solution or vapour for example).

Commercially available imprint templates (i.e., stamps or masters) for HE are usually fabricated from metals, e.g., from nickel, by using mechanical machining, laser ablation, or electroforming. These methods suffer from high cost and long production times. Stamps based on patterned silicon wafers are fragile and prone to breaking, especially, with repeated use. Similarly, masters produced from silicon wafers coated with a patterned photoresist are not robust, and they frequently suffer from poor adhesion of the photoresist to the wafer in the de-embossing step.

Imprint templates based on epoxy and polyester resins have been generated in a multi-step process by replicating a primary mold (usually, fabricated in poly(dimethyl siloxane)) and, have been used to pattern materials with relatively low glass transition temperatures, e.g., poly(methyl methacrylate). These drawbacks limit the implementation of HE for the production of microfluidic reactors.

Given the current techniques for making stamps for hot embossing (HE), there is a need for an economical, efficient and long-lived alternative. This is especially needed for users who require rapid prototyping of new designs for HE, such as those working in microfluidics. A major growth area using HE is microfluidics, particularly for chemical and biological sensors. Other, more established HE users include optical component manufacturers, particularly those making optical gratings.

### SUMMARY OF THE INVENTION

The present invention relates to a process for producing a stamp for hot embossing (HE). The stamp can be constructed from any resist that is rigid and otherwise stable at temperatures equal to the glass transition temperature of the material to be stamped. The stamp can be used repeatedly without significant distortion of features. The stamp benefits from low relative cost, high fidelity of features in all three-dimensions and fast construction.

Embodiments of the present invention provide a process for producing a stamp for hot embossing or nano imprinting lithography from a resist, comprising the steps of:

a) producing a seed layer L1 from a selected resist material;

b) soft baking the seed layer L1;

c) exposing said seed layer L1 to a polymerization agent to initiate cross-linking and then post-exposure bake L1 to fully cross-link it;

d) coating said cross-linked seed layer L1 with a resist layer L2;

e) soft baking the resist layer L2;

f) developing a pre-selected pattern of embossing features by covering said soft baked resist layer L2 with a mask with a pre-selected pattern and exposing unmasked regions of the soft baked resist layer L2 to a polymerization agent wherein the exposed regions form the pre-selected pattern of embossing features; and

g) washing away un-exposed regions of the resist layer L2 with a developer to leave behind a relief pattern of said pattern of embossing features formed in the resist layer L2, which relief pattern corresponds to the pre-selected pattern in the mask.

A further understanding of the functional and advantageous aspects of the invention can be realized by reference to the following detailed description and drawings.

### BRIEF DESCRIPTION OF THE DRAWINGS

Preferred embodiments of the invention will now be described, by way of example only, with reference to the drawings, in which:

FIG. 1 illustrates a hot embossing stamp produced in accordance with the present invention.

FIG. 2 shows the forces exerted on stamp during hot embossing.

FIG. 3 shows the steps involved in the process of producing a stamp for hot embossing with and without a stamp base.

FIG. 4 shows a schematic of the process of the fabrication of a SU-8/Cu HE imprint template for production of a microfluidic reactor.

FIG. 5 (a) shows a photograph of the imprint template (master) comprising a two-layer SU-8 film applied to a copper base plate and the fabricated microfluidic reactor for the synthesis of polymer particles (b), in (b) the emulsification compartment (i) and reaction compartments (ii) are highlighted with dashed boxes, scale bar is 1 cm.

FIG. 6 shows optical microscopy images (top view) of the orifice region on the two-layer SU-8/Cu master (a) and the corresponding patterned COP sheet (b). Scale bar is 200 μm. (c) The profile of the cross-section of the orifice acquired from the master (solid line) and the patterned COP sheet (dotted line). (d) The profile of the orifice cross-section on the imprint template before (solid line) and after (dotted line) 40 HE cycles.

FIG. 7 show scanning electron microscope (SEM) images (top view) of master's feature edges and protrusions for the masters fabricated using masks with resolution of 1,000 dpi (a) 5,080 dpi (b) and 20,000 dpi (c). In each case, the feature edge occupies the top portion of the image. Wall edges, extending horizontally along the middle of the images, appear brighter due to the charging of the SU-8 surface during image acquisition. Scale bars are 10 μm.

FIG. 8 shows emulsified droplets of (a) N-isopropylacrylamide (NIPAAm) in light mineral oil and (b) TPGDA in water in cycloolefin polymer (COP) the microfluidic reactor, sealed via methylcyclohexane (MCH)-activation. The flow rates of the droplet and continuous phases are (respectively) 0.1 mL/h and 1.0 mL/h in (a) and 0.05 mL/h and 1.0 mL/h in (b). The scale bars are 200 μm.

Table 1 shows relevant material properties and embossing conditions for thermoplastic materials COP, polycarbonate (PC) and Acrylic.

Table 2 lists the microreactor sealing conditions.

### DETAILED DESCRIPTION OF THE INVENTION

Generally speaking, the embodiments described herein are directed to processes for producing a stamp for hot embossing (HE). As required, embodiments of the present invention are disclosed herein. However, the disclosed embodiments are merely exemplary, and it should be understood that the invention may be embodied in many various and alternative forms.

The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, processes for producing a stamp for hot embossing (HE) are disclosed herein.

As used herein, the terms “about”, and “approximately” when used in conjunction with ranges of concentrations, temperatures or other physical or chemical properties or characteristics is meant to cover slight variations that may occur.

As used herein, the phrase “soft baking” is the process by which the resist is heated on a hot plate or convection oven to moderate temperatures (usually approximately 65° C.) thereby evaporating solvents in liquid resist and densifying the layer.

As used herein, the phrase “exposure” is the process by which the resist layer is selectively exposed to radiation after pre-baking. For negative resists, the exposed regions become initiated for cross-linking and form a permanent solid after post-exposure baking. Typically, photoresists use UV radiation (350-400 nm). Other resists are designed to be exposed to DUV radiation (below 250 nm) and to electron-beams and offer better resolution of exposed areas. For positive resists the irradiated areas are the ones which become soluble in the developer.

As used herein, the phrase “post exposure bake” means the process by which an exposed region of the resist becomes cross-linked into an irreversibly solidified shape.

As used herein, the phrase “developing” means the process by which soluble regions of the resist are washed away by a developing solvent, leaving behind only the cross-linked regions.

As used herein, the term “resist” refers to a radiation sensitive material that forms a patterned coating on a surface based on its exposure to photons (photoresists) or electrons (Ebeam resists). Negative resists form the patterned coating in the areas which are irradiated, positive resists form the patterned coating in the areas which are not irradiated. The term “resist” as used herein is not restricted to polymer-based resists but includes them.

For the purpose of this description we typically refer to negative photo-initiated resists (photoresists) but both positive or negative photoresists may be employed.

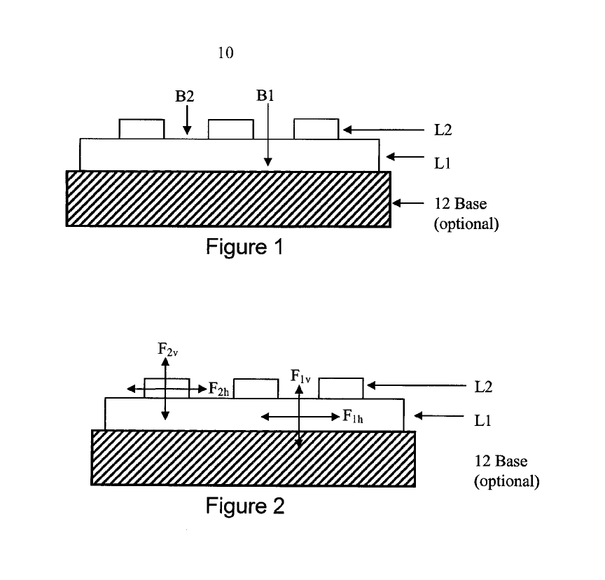

The stamp constructed in accordance with the present invention includes embossing features made from photo-cured epoxy (photoresist) seated on a layer of the same material (“seed layer”). Referring to FIG. 1, these are layers L2 (embossing features) and L1 (seed layer), respectively. These layers are separated by the boundary B2, which is only conceptual. The feature dimensions in L1 are made via standard photo-lithography can be no smaller than ½ of the wavelength of the UV light used to polymerize the photo-resist and are limited by the printing resolution of the mask. As such the minimum feature sizes features for a typical UV-photoresist are limited to 200 nm. DUV resists can feature resolution of approximately 100 nm, and e-beam resists in the 10's of nm. Features made from photoresists such as SU-8, which is used in the example discussed below, can achieve aspect ratios of greater than 10:1, see http://www.microchem.com/products/su_eight.htm

In the present invention the inventors have, when making stamp 10, used a base layer 12 (“stamp base”), which is made from another material on which the seed layer L1 sits. This is shown in FIG. 1. The stamp base 12 is a practical feature and not critical to the functionality of the stamp. Nevertheless, it is a useful feature and the present method involves coating the stamp base 12. The boundary between the base 12 and the seed layer (L1) is B1. We have tested silicon wafers as stamp bases which support various grades of SU-8 (http://www.microchem.com/products/su_eight.htm), but metal or other materials may be used, for example KMPR (http://www.microchem.com/products/su_eight.htm) coated on a nickel base. In some cases where bonding between the epoxy and stamp base material is relatively weak, the addition of a layer of adhesion-enhancing material, such as MCC 80/20 adhesion promoter (http://www.microchem.com/products/su_eight.htm) at B1 (between the stamp base 12 and the epoxy seed layer L1) may be used. The MCC Primer 80/20 adhesion promoter comprises 20% hexamethyldisilazane (HMDS) and 80% propylene glycol monomethyl ether acetate (PM Acetate).

The present method involves building stamp features (L2) on top of an epoxy seed layer (L1). The seed layer (L1) uniformly coats the stamp base 12, or is thick enough to support the entire stamp itself. In the case that the seed layer (L1) is atop a stamp base 12, it serves to increase the surface area of contact between the stamp base 12 and the epoxy, thereby enhancing bonding of the photo-resist to the stamp base 12 (if one is used). Control over the adhesion of a photo-resist to a substrate layer have been demonstrated by varying exposure wavelength dosage of UV light: Kim, Electrophoresis 2006, 27, 3284-3296.

Most importantly, it provides enhanced strength to the negative photo-resist features in L2 by virtue of the strong bond bonding across B1. This is due to the fact that epoxy sticks to itself far better than it does to other materials. In other words, the strength of the bonding across B1 is stronger when the seed layer L1 and L2 are both photo resist. Without the seed layer, L1, (i.e. in the case that the epoxy negative structures (L2) are bonded directly to the stamp base) forces acting on the stamp during HE can result in the epoxy structures becoming detached, see J. Micromech. Microeng. 11 (2001) 20-26.

FIG. 2 shows selected forces acting on the various parts of the stamp 10 during HE. Detachment is a result of a combination of two forces on the epoxy structures, (a) lateral forces (F₂ₕ) on the stamp's epoxy features as a result of differential thermal expansion/contraction properties between it and the substrate (which is being embossed) and between it and the stamp base; and (b) vertical forces (F₂ᵥ) from sticking of the penetrating epoxy features to the substrate during de-embossing. An anti-adhesive layer will reduce F₂ᵥ during de-embossing, but will not sufficiently protect the stamp from failure due to F₂ₕ, unless the seed layer is present. Furthermore, in the presence of the seed layer (L1), the enhanced bonding across B1 also helps prevent damage to the stamp features (L2) from F₂ᵥ, thereby enabling the user to use less or no anti-adhesive coating. Another advantage of using a seed layer is the reduced or eliminated need for further treatment of the stamp to re-enforce surface features, such as a vapour deposited layer of Ti or Al, which could change the dimensions of the structures, see Anal. Chem. 2006, 78, 788-792. Though such treatment could further enhance the strength of the stamp.

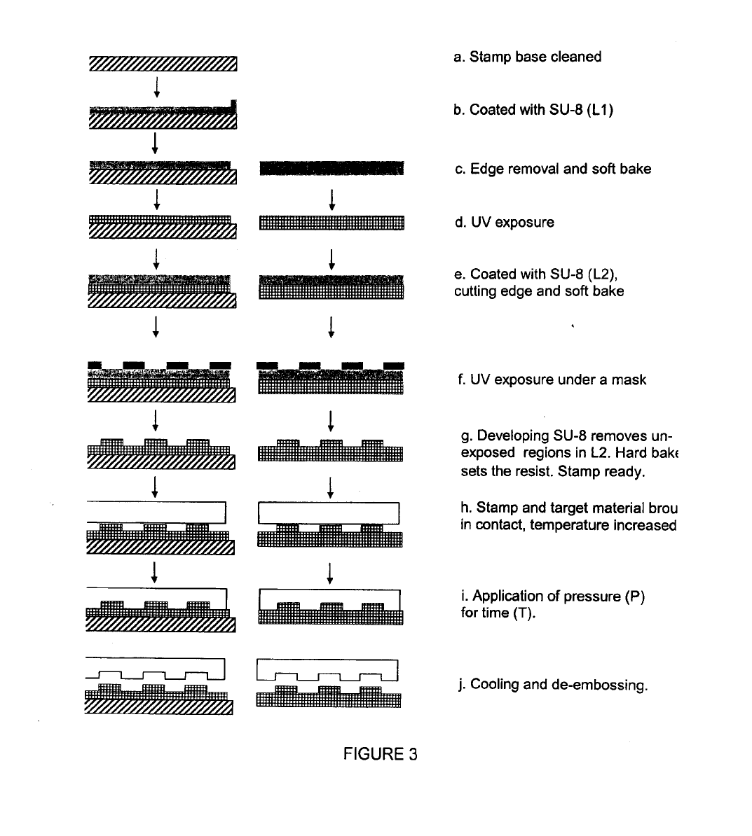

To illustrate this process, we will consider a hot embossing stamp that uses a silicon wafer base and uses SU-8 as the photoresist, similar to FIG. 1. FIG. 3 shows the different steps in the process of building such a stamp. The flow chart on the left side of FIG. 3 corresponds to the stamp 10 in FIG. 1 (with a base 12). The flow chart on the right side of FIG. 3 shows the process of building a stamp where the seed layer serves as the stamp's base.

Referring to FIG. 3, in step a. a stamp base is cleaned and prepared for spin coating when a substrate 12 is used. In the present example, where the stamp base is an Si wafer, the cleaning process typically involves sonication in acetone for 5 minutes, followed by sonication in methanol for 5 minutes and then air dried. Step b. shows the deposition of a seed layer L1 of SU-8 by spin coating. For this resist, layers of between <0.5 μm up to 200 μm can be deposited in a single coating. Multiple coatings can extend this range. Typically there exists a rim of photo-resist around the edge of the wafer which is relatively thick. The edge is removed to ensure that the height of the layer (L1) is uniform after baking. After edge removal, soft baking (step c.) then UV exposure of the entire seed layer L1 (step d.) occurs as per the photoresist manufacturer's specifications. Post exposure bake of L1 could be conducted at this stage or deferred until after the formation of the second layer. The second layer (L2) is spin coated over the first layer L1, its edges are removed and is soft baked (step e.). A mask is placed above L2 and it is selectively exposed (step f).

It has been shown that masks of higher dots per inch (DPI) resolution may yield smoother side walls. This is an important consideration from the perspective of ease of d-embossing.

The process described above used UV radiation as the polymerization agent which is usually typically used. However, it will be readily appreciated that other polymerization agents may be used, including but not limited to deep UV light, extreme UV light, electron beams, x-ray beams, I-line, G-line and H-line, in which the sources of these lines are mercury vapor lamp.

Features are transferred to L2 only (not L1) because the entire first layer (L1) has been previously exposed to the polymerization agent in step d. so that this layer is hardened.

For the purposes of enhanced ease of de-embossing or for certain application requiring channel cross-sections other than rectangular, a tapered wall angle may be preferable. This technique allows for the control over the dimensions of the features' cross-sections through either (i) control over dosage of UV light and (ii) control over UV wavelength, or a combination thereof. For example, larger dosages have been shown to give tapered side walls (eg. See: Chang, Sensors and Actuators A: Physical, Volume 136, Issue 2, 16 May 2007, Pages 546-553; J. Micromech. Microeng. 15 (2005) 2198-2203; Kim, Electrophoresis 2006, 27, 3284-3296).

Developing the (selectively exposed) surface of L2 results in unexposed areas being removed (step g.), leaving behind the embossing features. After a post exposure bake according to the manufacturer's specifications, the entire stamp is set and ready for use.

Steps h. to j. show how the stamp is used to transfer its features into the target material. This technique produces stamps with relatively high fidelity, because the stamps are created right from the photolithography step. On the other hand, other techniques involving thermally set epoxy include at least two other steps in addition to making a photoresist master: (1) manufacturing a mould (usually single use PDMS) and from the photoresist master, from which (2) stamps are then generated, see Sensors and Actuators B 107 (2005) 632-639. Also see European Patent: EP 1 413 923 A2 (Hewlett-Packard Development Company, L.P.) for a description of SiC stamps.

The method has been illustrated above using SU-8, it will be understood many other types may be used. In the case of SU-8, which has a glass transition temperature of 210° C., the types of substrates that could be patterned include, but are not limited to:

| Polymer type | | T_{g} |
|---|---|---|
| Polyethylene terephthalate | (PET) | 69 |
| Poly(vinyl alcohol) | (PVA) | 85 |
| Poly(vinyl chloride) | (PVC) | 81 |
| Polycarbonate | (PC) | 140-180 |
| Polystyrene | (PS) | 95 |
| Polymethylmethacrylate | (PMMA) | 105 |
| Cyclic Olifin Copolymer | (COC) | 135 |
| Cycloolefin Polymers | (COP) | 100-160 |

and some grades of Teflon (i.e., Dupont 601 grades T_{g}=160: http://store.fluoroproducts.com/teflonaf1.html).

Other viable resists that could be used include, but are not limited to: SU-8 series and SU-8 2000 series (Microchem), which are chemically amplified epoxy based negative resists; KMPR (Microchem) which is an epoxy-based photoresist, see (http://www.microchem.com/products/kmpr.htm), Megaposit SPR series (Rome and Haas), DUV ARC series (Brewer Science Inc.), and Diazonaphthoquinone-based resists (such as DNQ/Novolac).

Also, crosslinking of photoresists increases with post exposure bake temperature, thereby allowing for customizable mechanical properties like hardness and thermal expansion. Thermal expansion of the stamp's features should be negligible for SU-8, especially for heavily cross-linked stamps. Heavily crosslinked features may result in shrinkage of photoresist features. With proper calibration, this can be exploited to help reduce feature sizes beyond the photo lithographic limit.

The example above used spin coating to apply a uniform seed layer to a stamp base, but other techniques may be used, including but not limited to spray coating. In the case a stamp base is not used and the seed layer itself form the stamp base then pouring and soft baking in a simple non-stick container (for example Teflon) could produce base (L1) on which the second layer (L2) could be built.

The present method of producing stamps is very advantageous over the present method of making metal stamps (and SiC stamps) in terms of ease of production, quick turn around time (days) and low-cost. This is particularly suited for R&D, where new designs need to be implemented rapidly. Features are determined by lithography, such that the limits in the features' horizontal dimensions are dependant on the light source being used. Standard UV exposure for SU-8 products (minimum exposure wavelength 365 nm) result in feature limits below 200 nm. Other resists have different exposure requirements and feature limits. Also, tall features are easily made by spin coating, which results in layers between approximately 0.5 to 200 μm per coating (multiple coatings extend this range).

The method can also be used for stamp fabrication that will be used repeatedly. We have shown that after 40 embossing cycles in COP there was no measurable deformation of the stamp features.

The present method is also advantageous over etched Si in terms of lifetime and better control over feature dimensions. The method is also superior to thermally set high temp epoxy stamps created via a mould because (a) such stamps made from these materials have not been shown to be viable as a repeatable stamp in materials other than low T_{g} materials such as Poly(methyl methacrylate) (PMMA) (T_{g}˜100° C.), (b) are made from a mould (usually a single use PDMS mould), which reduces the feature size fidelity by introducing extra steps. As a result of (b), the fabrication time is also increased. For example, whereas the technique outlined here generates a stamp directly from the photolithography process, thermally set epoxy stamps require photolithography to create photoresist master, which is then used to make Polydimethylsiloxane (PDMS) mould. Epoxy is then poured into the mould and then degassed. Thermally set epoxies are also susceptible to warping if not carefully set. Finally, one must ensure backside of the stamp is properly planed.

### Example

The present method will be illustrated by the following example of a rapid, cost-efficient fabrication of microfluidic reactors in thermoplastic polymers by hot embossing using SU-8/Cu templates that were fabricated via photo-lithography. Specifically, the method is utilised to fabricate microfluidic reactors in a range of thermoplastic materials with the glass transition temperature, T_{g} in the range (113° C.≦T_{g}≦149° C.) and by using a standard temperature-controlled hydraulic press. Several different thermoplastic materials were used for the fabrication of microreactors by hot embossing including: a cycloolefin polymer (COP), a UV-transparent acrylic polymer, and polycarbonate (PC). The use of COP had advantages over two other polymers, owing to the combination of high transmission in the UV-Vis, relatively low viscosity at elevated temperatures, low water absorption, low fluorescence background, and its ability to activate its surface by O₂ plasma treatment. Therefore, whereas both the acrylic polymer and PC were successfully used for the fabrication of microreactors, most of the results disclosed herein are presented for the fabrication of microreactors in COP.

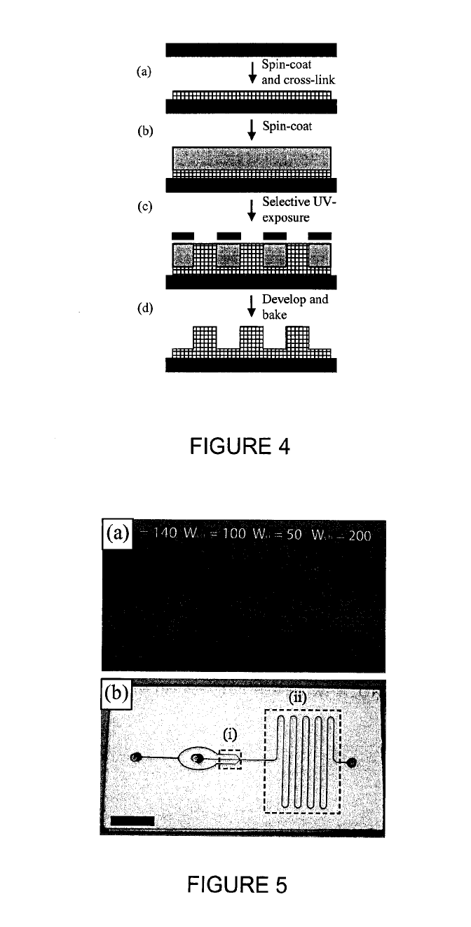

FIGS. 4a to 4d show the schematic of the fabrication of the master, which is a shortened version the process shown in FIGS. 3a to 3j. A seed layer of SU-8 3050 with the thickness of approximately 40 μm was spin-coated on a square copper base sheet with dimensions of 76×76×1 mm. The photoresist was subsequently crosslinked using UV-irradiation (MA6 mask aligner, SUSS Microtech) and baked at 90° C. (FIG. 4a). A second layer of SU-8 3050 with the thickness of 75-110 μm was spin-coated on top of the primary layer and soft baked at 95° C. for 40 min (FIG. 4b). The hardened SU-8 was then selectively cross-linked by placing a mask (resolution of 5080 dpi) with microreactor features on top of the second photoresist layer and exposing the system to UV-radiation (FIG. 4c). After removing uncrosslinked photoresist with SU-8 Developer (Microchem Corp.), the remaining photoresist was hardened at 175° C. for 2 hrs (FIG. 4d) and the imprint template was ready for use.

Thermoembossing was conducted with a hydraulic press (Model 3851-C Carver Inc., Wabash, Ind.) with temperature control of +1-1° C. of the top and bottom platens. The optimised embossing conditions are listed in Table 1 along with material properties relevant to the embossing process. All reported temperature measurements were taken directly from the platens. In a separate calibration measurement, we determined that sample temperatures were ca. 4-6° C. lower than the platen. The imprint template was loaded, with its features facing up, on to the bottom platen of the press. A 1 mm-thick sheet of the thermoplastic was placed on top of the imprint template (FIG. 3h). A square polished metal plate with dimensions 7.6 cm×7.6 cm was placed on top of the thermoplastic, with the polished side against it (in the case of PC, its relatively high water absorption required a dehydration step, which involved pre-heating of PC at roughly 80° C. for 40-80 minutes before embossing). A 1 mm-thick sheet of temperature resistant silicone rubber (Mcmaster-Carr 378T22) was used in order to redistribute possible pressure gradients.

The press was heated until top and bottom platens reached Tₑ and stabilised, then the pressure was increased to the required embossing pressure, Pₑ, (FIG. 3i), which resulted in the transfer of bas-relief features from the imprint template to the polymer sheet. Pressure was calculated by dividing the platen force by the total template surface area, not by the template's active feature area. After 5-10 minutes, the heaters were turned off and the system was cooled under pressure for 20-30 min. Once the temperature reached the de-embossing temperature (T_{d}), the pressure was reduced and platens were separated. The substrate was de-embossed (FIG. 3j) while the imprint template was in thermal contact with the heated platen, in order to avert thermal shock associated with rapid cooling. No mold release or anti-adhesion layer between the imprint template and substrate was required.

The thermoembossed microfluidic reactor in this example had the topography of a planar flow-focusing droplet generator followed by the polymerization compartment (the wavy downstream channel). FIG. 5 shows the imprint template and the sealed microfluidic reactor. The height of the channels was 106 μm and the total area of the embossed features was 230 mm².

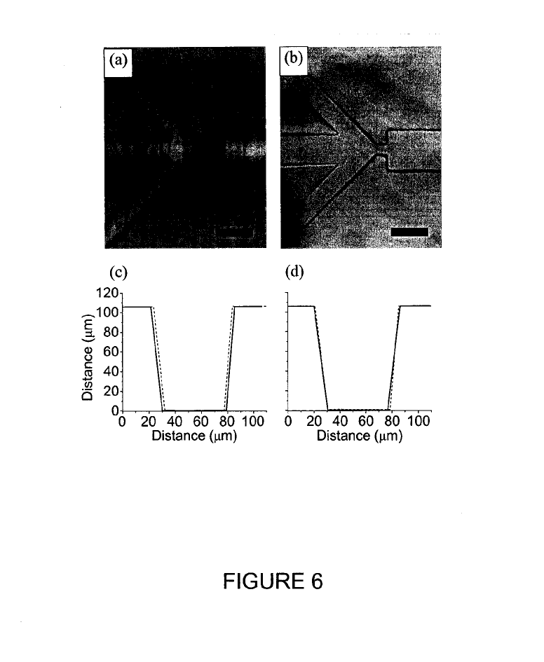

To assess the quality of the imprinting, we focused on the highest aspect ratio element of the reactor:the orifice region of the droplet generator. FIGS. 6a and b show optical microscopy images (top view) of the master and of the patterned COP sheet, respectively. The embossed features in the polymer were the exact inverse of the features of the master used for HE. In FIG. 6a defocused vertical microgrooves (the result of polishing of the copper sheet) are seen through the transparent photoresist layer.

The fidelity of the imprinting process was examined by comparing dimensions of the orifice on the mask, the master, and the imprinted pattern in COP. FIG. 6c shows a typical profile (acquired using optical profilometry) of the cross-section of the orifice in a master and the COP sheet. imprinted at Tₑ=166° C. and T_{d}=125° C. The side walls in both fabrication steps had the wall angle of 3.9°+/−0.5° from the normal. The imprinted orifice had a 3 μm smaller width, which led to the 6% decrease in its volume, compared to the master. We note that the fidelity in the HE process benefited from the closer match of SU-8 thermal expansion coefficient (α=52 ppmK⁻¹) to that of the thermoplastic polymers used (Table 1), compared to templates made from silicon (α=3.3 ppmK⁻¹) or Ni (α=14.4 ppmK⁻¹).

The HE process conducted with the SU-8/Cu master had high fidelity of imprinting over the course of many cycles. Using a single SU-8/Cu master, we imprinted 40 microfluidic reactors in COP with the average orifice width at the bottom and the top of 44.8 μm+/−1.0 μm and 58.5 μm+/−2.1 μm, respectively. The tapering angle was in the range from 2.5° to 5.4°, with an average of 3.7°+/−1.3°. The tapering angle depended on the embossing temperature and pressure and it was minimised for Tₑ≧155° C. and Pₑ=600 kPa. The SU-8/Cu imprint template was durable: after 40 HE cycles, the features of template did not noticeably change (FIG. 6d). We attribute the durability of the imprint template to four factors minimising stresses in the de-embossing step: (i) matched thermal expansion coefficients (a) of the master and thermoplastic polymers, (ii) smooth template walls, (iii) the existence of a seed protoresist layer and (iv) strong adhesion of the photoresist to the copper base.

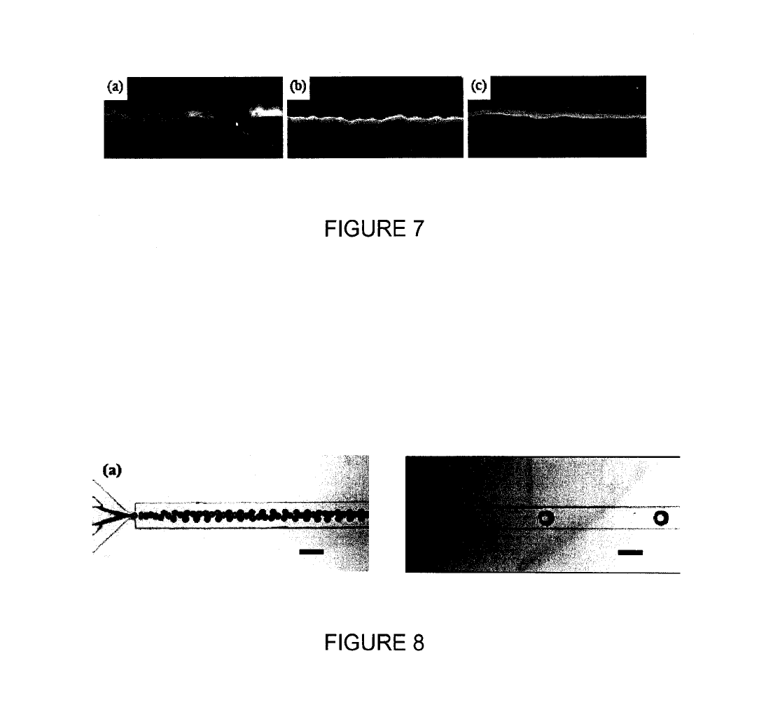

The selection of copper (α=18.0 ppmK⁻¹) as the base material also made it superior to e.g., silicon, owing to the closer match of thermoexpansion properties of copper and SU-8. Low surface roughness of the walls of the master minimised friction between the template and the thermoplastic polymer during de-embossing. To investigate the effect of the resolution of the printed photomask on the smoothness of the side walls, multiple SEM images were acquired from the masters prepared from masks printed at resolution of 1,000, 5080 dpi, and 20,000 dpi. Representative images are shown in FIG. 7. Based on the SEM images, the surface roughness was quantified by calculating the surface distance index (SDI). SDI=dₛ/d (1), where dₛ is the measured path length (encompassing wall roughness) between two points along the embossing feature wall and d is the distance of a straight line between the same two end points. From eq. (1), SDI was calculated to be 1.06, 1.008, and 1.0001 for the imprint templates fabricated from the masks printed at the resolution 1,000, 5,080 and 20,000 dpi, respectively.

The seed photoresist layer increased the adhesion of the patterned SU-8 layer to the master base and prevented its peeling during de-embossing. Furthermore, based on shear force tests, adhesion of SU-8 3050 to copper is the strongest compared to any other substrate, including silicon (see: http://www.microchem.com/products/pdf/SU-8-Adhesion-Results.pdf)

In the next step, we bonded the patterned and a planar sheet of the thermoplastic polymer by first activating the surfaces, followed by sealing via the application of pressure and temperature lower than T_{g}. Conditions used in the sealing step are given in Table 2. Surface activation for low-temperature sealing of COP microreactors was achieved by exposing the polymer sheets to either O₂ plasma in a plasma chamber for 30 sec at 0.8 mBar or to the vapour of methylcyclohexane (MCH). In the latter case, the COC sheets and 2 mL of MCH were placed a preheated to 30° C. glass-covered Petri dish for 3.5 min. To seal PC or acrylic polymer sheets we used air plasma activation for 30 sec at 0.8 mBar. Following activation, the patterned and non-patterned polymer sheets were brought in contact and loaded into a hydraulic press, which was preheated to the bonding temperature, T_{b}. A thin sheet of rubber was placed between the top platen and the polymer sheets to distribute even pressure across the entire polymer surface.

Following bonding, we allowed the sealed microfluidic device to cool down slowly (t_{c}) to room temperature under the pressure P_{b}, in order to prevent the build-up of thermal stress. In some cases a subsequent annealing cycle to 85° C. was implemented to further reduce thermal stress, thereby suppressing solvent cracking in the presence of mineral oil and monomers. In the case of both MCH and O₂ plasma activation, bonding was strong (e.g., when MCH activation was used, we were able to achieve flow rates in excess of 160 mL/h) and the channel dimensions were not noticeably altered.

Finally, the fabricated devices were utilized for the emulsification of an aqueous solution comprising N-isopropyl acrylamide, a photoinitiator, and a crosslinking agent in a light mineral oil FIG. 8 shows he results of emulsification conducted in COP microreactors imprinted with the SU-8/Cu stamp and sealed with MCH-activated bonding. We conducted emulsification of an aqueous monomer solution comprising 5 wt % NIPAAm, 0.5 wt. % of BIS, and 0.25 wt. % of HMPP in light mineral oil comprising 4 wt. % of surfactant Span 80 (FIG. 8a). In a second experiment, we emulsified tripropylene glycol diacrylate (TPGDA) mixed with 2 wt. % surfactant Tween 80 and (HCPK) in water comprising 3 wt. % of Triton X-100 (FIG. 8b). The interfacial tension between the droplet phase and continuous phases were 2.8 mN/m and 0.83 mN/m for systems shown in FIGS. 8a and 8b, respectively. The diameters of approximately 200 droplets were measured using optical microscopy, yielding a mean diameter (dₘ) and polydispersity or coefficient of variance (CV) of the droplets. The value of CV was calculated as δ/dₘ×100%, where δ is the standard deviation of droplet diameters. The droplets shown in FIG. 8a had dₘ=47 μm and CV=1.5%. The droplets shown in FIG. 8b had dₘ=124 μm and CV=2.6%.

We used photolithographically generated imprint templates (masters) for the HE-based fabrication of microfluidic reactors in a range of thermoplastic polymers. The method disclosed herein has two important implications: fast fabrication of robust, low-cost SU-8/Cu masters (4 stamps in 6-8 hr) and the subsequent high-fidelity fabrication of thermoplastic microreactors (ca. 2 hr/reactor). The imprint template is durable in multiple imprinting steps. These features are beneficial in rapid prototyping of microfluidic reactors.

In addition to the present stamps being useful for producing high-fidelity fabrication of thermoplastic microreactors, stamps may also be made using the present method for fabrication of optical grating elements in thermoplastic materials.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

TABLE 1

| | Material Properties | | | | | | | | |
|---|---|---|---|---|---|---|---|---|---|
| | Glass | | Thermal | Embossing Conditions | | | | | |
| | transition | Wetting | expansion | Heating | Embossing | De-embossing | | | Cooling |
| | temperature, | angle, | coefficient, | time, | temperature, | temperature, | Pressure, | Time, | time, |
| | T [symbol] | θ [symbol] | α | [symbol] | T [symbol] | T_{d} | P [symbol] | [symbol] | [symbol] |
| Material | ° C. | deg | ppm K⁻¹ | min | ° C. | ° C. | kPa | min | min |
| COP | 138 [symbol] | 84 +/− 2 | 70 | 15 | 155 +/− 0.5 | 100-125 +/− 0.5 | 400-620 | 10 | 20 |
| Acrylic | 113^{b} | 64 +/− 1 | 52 | 15 | 117 +/− 0.5 | 90 +/− 0.5 | 400-620 | 10 | 20 |
| PC | 149^{b} | 68 +/− 2 | 58 | 20 | 170 +/− 0.5 | 110 +/− 0.5 | 400-620 | 10 | 30 |

T_{g} is the glass transition temperature, measured by differential scanning calorimetry (a) or given by manufacturer (b).
θ_{w} is the wetting angle for a droplet of water on the original material surface.
t_{d} is the material dehydration time at 80° C. as recommended by PC manufacturer. [symbol]
indicates data missing or illegible when filed

TABLE 2

| | Surface | tₑₓₚ | T_{b} | P | t_{b} | t_{c} |
|---|---|---|---|---|---|---|
| Material | Activation | (sec) | (C) | (MPa) | (min) | (min) |
| COP | Solvent^{a} | 210 | 70-110 | 1.0-3.0 | 10 | 30-40 |
| COP | Plasma^{b} | 90 | 70-110 | 1.0-3.0 | 10 | 30-40 |
| Acrylic | Plasma^{c} | 90 | 60-80 | 1.0-3.0 | 10 | 30-40 |
| PC | Plasma^{c} | 90 | 70-110 | 1.0-3.0 | 10 | 30-40 |

^{a}Solvent used was methylcyclohexane.
^{b}O₂ plasma
^{c}Air plasma
tₑₓₚ is the time of exposure to either plasma or solvent vapour.
Bonding conditions include bonding temperature, pressure and time (T_{b}, P, t_{b}) and cooling time t_{c} while under pressure.

1. A process for producing a stamp for hot embossing or nano imprinting lithography from a resist, comprising the steps of:
a) producing a seed layer L1 from a selected resist material;
b) soft baking the seed layer L1;
c) exposing said seed layer L1 to a polymerization agent to initiate cross-linking and then post-exposure bake L1 to fully cross-link it;
d) coating said cross-linked seed layer L1 with a resist layer L2;
e) soft baking the resist layer L2;
f) developing a pre-selected pattern of embossing features by covering said soft baked resist layer L2 with a mask with a pre-selected pattern and exposing unmasked regions of the soft baked resist layer L2 to a polymerization agent wherein the exposed regions form the pre-selected pattern of embossing features; and
g) washing away un-exposed regions of the resist layer L2 with a developer to leave behind a relief pattern of said pattern of embossing features formed in the resist layer L2, which relief pattern corresponds to the pre-selected pattern in the mask.

2. The process according to claim 1 wherein the resist layer L2 is made of the same material as seed layer L1.

3. The process according to claim 1 wherein the resist layer L2 is made of a different material as seed layer L1.

4. The process according to claim 1 wherein said seed layer L1 is deposited using any one or combination of spin coating and spray coating.

5. The process according to claim 1 wherein said seed layer L1 is grown from a positive resist material.

6. The process according to claim 1 wherein said seed layer L1 is grown from a negative resist material.

7. The process according to claim 1 wherein said seed layer L1 is grown on a rigid stamp base.

8. The process according to claim 7 wherein said rigid stamp base is selected from the group consisting of semiconductors, glass, metals, and plastics.

9. The process according to claim 1 including a step of depositing an adhesion layer onto the seed layer L1 after step c) and before step d).

10. The process according to claim 9 wherein said adhesion layer includes about 20% HMDS and 80% PM Acetate.

11. The process according to claim 1 wherein said polymerization agent is UV light.

12. The process according to claim 1 wherein said polymerization agent is selected from the group consisting of deep UV light, extreme UV light, electron beams, x-ray beams, I-spectral line, G-spectral line and H-spectral line obtained from a mecury arc lamp.

13. A stamp for hot embossing or nano imprinting lithography from a resist made according to the process of claim 1.

14. The stamp according to claim 13 characterized in that it can be used a plurality of times for embossing patterns.

15. The stamp according to claim 13 characterized in that it can be used for high-fidelity fabrication of microreactors in thermoplastic.

16. The stamp according to claim 13 characterized in that it can be used for fabrication of optical grating elements in thermoplastic materials.
